(19) United States
(12) Patent Application Publication
(10) Pub. No.: US 2025/0041889 A1
(43) Pub. Date: Feb. 6, 2025

(54) JOINT DEVICE, IN PARTICULAR FOR CARRYING AN APPLICATION APPARATUS

(71) Applicant: Dürr Systems AG, Bietigheim-Bissingen (DE)

(72) Inventors: Sven Schweigler, Bietigheim-Bissingen (DE); Heiko Kamp, Freiberg a.N. (DE)

(21) Appl. No.: 18/718,973

(22) PCT Filed: Jan. 10, 2023
(86) PCT No.: PCT/EP2023/050404

§ 371 Date: Jun. 12, 2024

(30) Foreign Application Priority Data
Jan. 12, 2022 (DE) 10 2022 100 609.3

(51) Int. Cl. B05B 15/65; B05B 15/68; B25J 9/10; B25J 11/00; B25J 19/00

(52) U.S. Cl. CPC B05B 15/65; B05B 15/68; B25J 11/0075; B25J 19/0025; B25J 9/1025; B25J 19/0004

(57) ABSTRACT

The disclosure relates to a joint device, preferably a robot hand, preferably for carrying an application apparatus in particular comprising a print head device, with a first joint structure which is rotatable about a first axis, and a line feed-through preferably in which at least one line runs, wherein the joint device comprises a forced guidance device, having a rotary part, for forced guidance of the line feed-through, and the rotary part is rotatable about a central axis of the forced guidance device.

### CROSS-REFERENCE TO RELATED APPLICATIONS

This application is a national stage of, and claims priority to, Patent Cooperation Treaty Application No. PCT/EP2023/050404, filed on Jan. 10, 2023, which application claims priority to German Application No. DE 10 2022 100 609.3, filed on Jan. 12, 222, which applications are hereby incorporated herein by reference in their entireties.

### FIELD

The disclosure relates to a joint device (e.g. a robot hand), in particular for carrying an application apparatus and preferably for mounting on an application robot. The application apparatus and/or the application robot is preferably used for painting motor vehicle body components.

### BACKGROUND

Robot-guided atomizers (e.g. rotary atomizers) for painting motor vehicle body components are, for precise path guidance, usually mounted on an actuator, referred to as a robot hand or robot hand axis, which usually comprises a plurality of joints coupled with each other. An example of such a robot hand (robot hand axis) and such an atomizer is disclosed, e.g., in EP 1632 320 A1. However, atomizers have the disadvantage of limited application efficiency because usually only part of the applied paint is deposited on the components to be coated, while the rest of the applied paint has to be disposed of as so-called overspray. A more recent line of development, on the other hand, envisages so-called print heads as the application apparatus, such as those known from DE 10 2013 002 412 A1 and DE 10 2010 019 612 A1. In contrast to the known atomizers, such print heads do not emit a spray mist of the paint to be applied, so that substantially no undesired overspray is produced.

In addition to the supply of the atomizers or print heads with e.g. electricity, paint, air, etc., also a wiring e. g. of the electric drive systems for the robot hand is necessary. Also a supply of the drive systems, in particular their motors, with air for cooling purposes and/or a flushing of robot housings with air, e.g. due to use in potentially explosive areas, can be necessary.

The line guidance poses central demands for this, wherein two different philosophies in particular have become established on the market to fulfill these demands, namely the internal line guidance and the external line guidance.

With the internal line guidance, the media hoses and cables are guided centrally through a robot hand. This routing requires in particular hollow shaft gears and motors that are offset to the gear. When the robot hand moves, the lines (e.g. cables, hoses, etc.) are twisted. With this load, care must be taken to ensure that the lines are dimensioned sufficiently long. It must also be ensured that the lines do not come into contact with sharp edges or rough surfaces, as this could damage them.

With the external line guidance, the media hoses and cables are guided in particular externally along the geometry of the robot. This routing does not place any great demands on the design of the gears and the mounting of the motors. When the robot hand moves, the lines (e.g. cables, hoses, etc.) are usually entrained by entraining devices and, if necessary, support points and run mostly freely in the space there-between. The external line guidance requires a relatively large amount of space and therefore increases the interference contour of the robot and/or the robot hand. Furthermore, external lines are unprotected and susceptible to soiling.

### BRIEF DESCRIPTION OF THE DRAWINGS

FIG. 1 shows a perspective view of a joint device according to an embodiment of the disclosure,

FIG. 2 shows another perspective view of the joint device,

FIG. 3 shows a view of the joint device from below,

FIG. 4 shows a view of the joint device from above,

FIG. 5 shows a perspective view, in particular of a line feed-through and an optional additional line feed-through for the joint device,

FIG. 6 shows a side view of the line feed-through and the additional line feed-through,

FIG. 7 shows another side view of the line feed-through and the additional line feed-through,

FIG. 8 shows a perspective view of a joint device according to an embodiment of the disclosure,

FIG. 9 shows a side view of the joint device,

FIG. 10 shows another perspective view of the joint device,

FIG. 11 shows a perspective view of the joint device, in particular with a measuring device for measuring rotary positions of a second joint structure of the joint device,

FIG. 12 shows a perspective view of the articulation device, in particular with a measuring device for measuring rotary positions of a third joint structure of the joint device, and

FIG. 13 shows a schematic view of an application robot with a joint device according to an embodiment of the disclosure, and

FIG. 14 shows an example of a schematic strain wave gear.

### DETAILED DESCRIPTION

The disclosure relates to a joint device (in particular a robot hand, e.g. robot hand axis), preferably for carrying an application apparatus and/or e.g. for mounting on an application robot. The application apparatus can comprise, e. g., a print head device.

The joint device comprises a first joint structure which is rotatable about a first axis.

The joint device can also comprise, e. g., a second joint structure which is rotatable about a second axis.

The joint device can also comprise, e. g., a third joint structure which is rotatable about a third axis.

The joint device comprises a line feed-through (e.g. a hose or a (e.g. flexible) tube). The line feedthrough can preferably form a (e.g. flexible and/or form shaping) empty tube.

It is possible that at least one line, e.g. at least one hose (e.g. media hose) and/or at least one cable (e.g. a control cable (e.g. a data cable) and/or a cable for preferably electrical power supply), runs in the line feed-through.

The joint device comprises a forced guidance device, having a rotary part, for forced guidance of the line feed-through, wherein the rotary part is rotatable about a central axis of the forced guidance device, in particular about a central axis of the rotary part, e.g. by more than 180° or by less than 180°.

The central axis of the forced guidance device is preferably defined by the central axis of the rotary part.

It is possible that the forced guidance device comprises a hollow cylindrical, in particular externally arranged, cover.

The rotary part can, e. g., be arranged at least partially inside the cover.

The rotary part preferably comprises a groove (e.g. a slot) and can therefore in particular form a slotted rotary part.

The rotary part can, e. g., be configured substantially cylindrical, in particular substantially hollow-cylindrical.

The cover can, e. g., be configured rotatable or non-rotatable.

It is possible that the cover is configured, e. g., in two or multiple parts, preferably with a first part that is expediently non-rotatable and a second part that is expediently rotatable. The second part can preferably be connected to the first joint structure, e.g. directly or indirectly, in particular in order to be able to rotate advantageously together with the first joint structure. Here, e. g., a drive of the first joint structure can be advantageously used to rotate the second part.

The rotary part and the hollow cylindrical cover can preferably be arranged substantially coaxially.

The first axis of the joint structure and the central axis of the forced guidance device are preferably substantially coaxially aligned with each other.

In the context of the disclosure, the first axis of the joint structure and the central axis of the forced guidance device can thus preferably represent one and the same axis.

The line feed-through can be connected, expediently indirectly or directly, to the first joint structure, in particular such that, by rotating the first joint structure, the forced guidance device and/or the rotary part can be expediently driven and rotated by means of the line feed-through.

In a preferred embodiment, the line feed-through can be connected to the first joint structure, expediently indirectly or directly, in order, by rotating the first joint structure, to rotate the forced guidance device and/or the rotary part, preferably by means of the line feed-through, advantageously with a reduced speed and/or reduced rotation angle relative to the first joint structure, e. g. with substantially half the speed and/or with substantially half the rotation (e.g. half rotation angle).

However, it should be mentioned that the cover is preferably not driven by the line feed-through. In the event that the cover is configured, e. g., rotatable and rotates with the first joint structure, it is preferably driven by the drive of the first joint structure.

The forced guidance device and/or the rotary part can thus be configured to rotate relative to the first joint structure, preferably with substantially half speed and/or substantially half rotation, although embodiments with another reduction ratio are also possible, e. g., if the line feed-through is deflected more than once.

If the first joint structure rotates, e. g., by 180°, the forced guidance device and/or the rotary part preferably rotates by 90°. If the first joint structure rotates, e. g., by 90°, the forced guidance device and/or the rotary part preferably rotates by 45°. If the first joint structure rotates, e. g., by 45°, the forced guidance device and/or the rotary part preferably rotates by 22.5°.

The range of rotation and/or pivoting of the first joint structure can, e. g., comprise at least one revolution (e.g. approximately 360°, in particular approximately +/−180°), at least two (e.g. approximately 720°), at least two and a half (e.g. approximately 900°), at least three (e.g. approximately 1080°) or at least three and a half (e.g. approximately 1260°) revolutions. For this purpose, the line feed-through can be laid in several windings.

The joint device, preferably the forced guidance device, can comprise, e. g., a first section and a second section.

For example, the first section and the second section can be spaced apart from each other preferably in axial direction of the forced guidance device.

The first section can, e. g., be configured to face an application robot.

The second section can, e. g., be configured to face the application apparatus and/or the print head device.

The line feed-through can preferably be configured, by rotation of the first joint structure, to be wound up, in particular spirally, in the first section and to be unwound, in particular spirally, correspondingly in the second section and vice versa. The line feed-through can thus preferably by rotation of the first joint structure be wound up in the first section and unwound correspondingly in the second section, wherein if the first joint structure is rotated in the opposite direction, the line feed-through can be expediently unwound in the first section and wound up correspondingly in the second section.

It is possible that the line feed-through is configured to be, preferably spirally, wound up and unwound in the first section at least half a time, at least once, at least once and a half times, at least twice, at least twice and a half times, at least three times or at least three and a half times. Alternatively or additionally, the line feed-through can be configured to be, preferably spirally, wound up and unwound in the second section at least half a time, at least once, at least once and a half times, at least twice, at least twice and a half times, at least three times or at least three and a half times.

The forced guidance device preferably comprises a groove (e.g. a slot, a depression, a recess or an elongated hole, etc.), in which the line feed-through can be, expediently partially, preferably forcibly guided accommodated.

The groove can be expediently formed in the rotary part.

The rotary part can thus be a slotted, preferably substantially ring-shaped and/or hollow cylindrical rotary part.

The groove is preferably configured substantially arc-shaped and can, e. g., form a deflecting arc for deflecting the line feed-through, preferably between the first section and the second section.

The groove can, e. g., effect a change of direction, in particular a reversion of direction, of the line feed-through expediently between the first section and the second section.

It is possible that the groove is rotatable about the central axis of the forced guidance device and/or is limited by a convex partial segment and an opposing concave partial segment, preferably of the rotary part. Alternatively or additionally, the groove can preferably be arranged between the first section and the second section, in particular in order to connect the line feed-through in the first section to the line feed-through in the second section.

For example, an expediently arc-shaped section of the line feed-through runs in the groove.

The groove and preferably therefore the forced guidance device and/or the rotary part can be rotated about the central axis of the forced guidance device, e. g., by means of the particularly arc-shaped section of the line feed-through. As already mentioned, the line feed-through and thus the section in the groove can be driven expediently by the rotation of the first joint structure, so that due to this the rotary part rotates.

In particular, the line feed-through can have a section that runs expediently arc-shaped in the groove in order to enable a transmission of force from the line feed-through to the rotary part, so that the rotary part can be set in rotation about the central axis of the forced guidance device.

It is possible that the line feed-through is slidable partially through the groove, e.g. is slidable partially out of the groove and partially into the groove, in particular when the groove is rotated, in order to advantageously enable winding up of the line feed-through in the first section and unwinding of the line feed-through in the second section and vice versa.

The rotary part and/or the groove is preferably configured to be axially slidable, in particular slidable along the central axis of the forced guidance device.

The rotary part 403 can, e. g., be slid back and forth along the central axis of the forced guidance device when the line feed-through is wound up and unwound.

The cover is preferably non-slidable along the central axis of the forced guidance device.

The line feed-through can have at least one winding in the first section and at least one winding in the second section.

It is possible that the line feed-through has at least one winding in the first section and branches off, in particular laterally, from the winding in the first section into the groove and/or has at least one winding in the second section and branches off, in particular laterally, from the winding in the second section into the groove.

It is possible that the groove and/or the in particular arc-shaped section of the line feed-through in the groove has a passage cross-section with a center axis aligned substantially parallel to the central axis of the forced guidance device and/or has a chord that runs substantially parallel to the central axis of the forced guidance device. This can, e. g., enable a deflection and/or a reversion of the direction of the line feed-through, e.g. along the line feed-through the direction is reversed in which the line feed-through winds around the central axis of the forced guidance device.

An inlet and an outlet of the groove can, e. g., be arranged on a straight line aligned substantially parallel to the central axis of the forced guidance device and/or aligned substantially perpendicular to the central axis of the forced guidance device.

It is possible that the line feed-through in the first section and in the second section extends preferably spirally in opposite directions around the central axis of the forced guidance device, so that, e. g., at least one winding of the line feed-through in the first section is aligned in opposite direction to at least one winding of the line feed-through in the second section.

It is possible that a winding (e.g. an at least 360° winding) of the line feed-through in the first section and a winding (e.g. an at least 360° winding) of the line feed-through in the second section are aligned in winding planes that are not parallel to each other.

It is possible that the line feed-through is, in particular in the first section, preferably non-slidably attached (e.g. fixed) at a first attaching point (e.g. clamping point), and/or is, expediently in the second section, preferably non-slidably attached (e.g. fixed) at a second attaching point (e.g. clamping point).

The second attaching point can preferably be rotatable relative to the first attaching point.

The first attaching point can, e. g., be configured non-rotatable.

The first joint structure can be connected, expediently indirectly or directly, to the second attaching point in order to rotate the second attaching point, whereby expediently the line feed-through and thus the rotary part can be driven.

It is possible that the line feed-through, e. g., does not extend completely around the central axis between the first section and the second section.

It is possible that the line feed-through and/or the at least one line is connected to a distributor box (e.g. an electronic interface), e.g. connects to a distributor box.

The distributor box can preferably be attached to the first joint structure or to a robot hand in general, in particular to rotate with the first joint structure.

It is possible that the forced guidance device, as already mentioned, comprises a, preferably substantially hollow cylindrical, cover.

The cover is used in particular for, expediently at least partially and/or externally, covering the rotary part, the groove, the line feed-through, the arc-shaped section of the line feed-through, the line feed-through in the first section and/or the line feed-through in the second section. The cover can, e. g., encase one or more of the aforementioned parts, preferably radially outside.

The cover is preferably configured to be removable.

The cover can, e. g., be configured to be hinged open and hinged closed or, e. g., comprise two shells demountable from each other.

The cover can preferably be arranged substantially coaxially to the central axis of the forced guidance device and, e. g., externally encase the rotary part.

It is possible that the cover is rotatable as part of the forced guidance device, e.g. rotatable expediently together with the rotary part and/or the groove.

The cover offers advantageously protection against external influences, has a low tendency to become soiled and is easy to clean.

Repair works and the replacement of hoses and cables can be carried out, expediently with removed cover, more easily on the outside than with an internal line guidance.

The cover can, e. g., have an outer sheath, wherein a passage opening can be formed in the outer sheath, from which the line feed-through expediently extends out of the cover. The line feed-through can, e. g., extend substantially tangentially out of the cover. Alternatively or additionally, the line feed-through can, e. g., extend out of the cover substantially parallel to a plane extending orthogonally to the central axis of the forced guidance device.

The joint device can, e. g., comprise an application apparatus.

It is possible that the joint device carries, expediently indirectly or directly, the application apparatus and/or the application apparatus is connected, expediently indirectly or directly, to the third joint structure.

The application apparatus preferably comprises a print head device, in particular with a plurality of nozzles for dispensing an application agent (e.g. paint) onto, e. g., a motor vehicle body component (e.g. a body and/or an attachment part therefor). Alternatively, the application apparatus can also comprise another applicator, e.g. a rotary atomizer, only a single dispensing nozzle, etc.

The print head device is used in particular for substantially overspray-free coating of motor vehicle body components.

The joint device can comprise, e. g.: the first joint structure, which is rotatable about the first axis, and a second joint structure, which is rotatable about a second axis, and/or a third joint structure, which is rotatable about a third axis.

The joint device can, e. g., have an additional line feed-through, which can extend (e.g. axially) through the forced guidance device, in particular the rotary part and/or the cover. Alternatively or additionally, the additional line feed-through can extend (e.g. axially) through the first joint structure and/or (e.g. axially) through the third joint structure.

It is possible that the additional line feed-through, e.g. in the first joint structure and/or in the third joint structure, has a passage cross-section of preferably at least 40 mm to a maximum of 90 mm, preferably of e.g. 70 mm+/−5 mm.

The additional line feed-through can be provided in addition to the line feed-through already discussed.

It is possible that at least one further line, e.g. at least one hose (e.g. media hose) and/or at least one cable (e.g. a control cable (e.g. a data cable) and/or a cable for in particular electrical power supply), runs in the additional line feed-through.

The at least one further line can preferably comprise at least one media line (e.g. a media hose), for application agent supply (e.g. paint supply) and/or for fluid supply (e.g. air supply, compressed air supply and/or rinsing agent supply) of the application apparatus and/or the print head device.

Alternatively or additionally, the at least one further line can comprise at least one cable, e.g. for electrical power supply and/or for control of the application apparatus and/or the print head device.

The at least one further line can also comprise, e. g., at least one media return line (e.g. a media hose) for returning a fluid (e.g. application agent (e.g. paint), air, compressed air and/or rinsing agent) from the application apparatus and/or the print head device.

The application agent is preferably a paint (e.g. water paint, solvent-based paint, base paint and/or clear paint).

However, the application agent can also comprise, e. g., a wax (e.g. preservative wax), a thickener, a sealant, an insulating material or an adhesive.

The joint device expediently comprises a particularly fixed offset (e.g. an offset) between the first axis and the second axis, so that the first axis and the second axis are preferably arranged fixedly offset to one another.

It is possible that the additional line feed-through also extends (e.g. axially) through the second joint structure. The at least one further line can also preferably extend through the second joint structure.

The first axis and the third axis can, e. g., extend in a common plane, e. g. even if they are rotated about their axes. It is possible that the second axis crosses the common plane, preferably crosses substantially orthogonally. This can advantageously enable that, when the joint structures rotate abound their axes, the additional line feed-through and/or the at least one further line is not kinked, but bent (and, e. g. also twisted).

It is possible that the first joint structure is an (e.g. kinematically) inlet-sided joint structure of the joint device and/or the third joint structure is an (e.g. kinematically) outlet-sided joint structure of the joint device.

The second joint structure can preferably be coupled (e.g. kinematically) between the first joint structure and the third joint structure.

It is possible that the first joint structure comprises a gear, preferably a strain wave gear.

Alternatively or additionally, the second joint structure can comprise a gear, preferably a strain wave gear. The strain wave gear of the first joint structure and/or of the second joint structure is preferably configured as a reduction strain wave gear in order to be able to advantageously generate the required rotary moment.

A strain wave gear (e.g. also known as tension strain wave gear, sliding wedge gear or according to the English designation strain wave gear (SWG)) is a gear with, in particular, an elastic transmission element, which is advantageously characterized by an expediently high gear ratio or gear reduction and expediently high accuracy with, in particular, low weight and, in particular, small dimensions.

A gear, e.g. strain wave gear, in the context of the disclosure comprises, e. g., at least one of the following:
a substantially elliptical disk (e.g. wave generator). The elliptical disk can comprise, e. g., a centric hub and/or a (expediently thin and/or elliptically) deformable bearing (e.g. ball or roller bearing). The elliptical disk preferably serves as drive element of the gear; and/or
a deformable cylindrical bushing with external toothing (e.g. flex spline). The bushing serves in particular as output element of the gear; and/or
a (expediently substantially rigid) cylindrical outer ring with internal toothing (e.g. circular spline). The outer ring can preferably surround the elliptical disk and the bushing; and/or
The outer toothing of the bushing preferably has at least one tooth less than the internal toothing of the outer ring.

It is possible that the first joint structure comprises a drive (e.g. motor, in particular electric motor) in order to rotate the first joint structure about the first axis. The drive of the first joint structure can be coupled, e. g. without own housing and/or without own bearing, to the first joint structure. The drive of the first joint structure can, e. g., be configured as a kit motor, which preferably comprises a rotor and a stator. In particular, the first joint structure can form a (e.g. ring-shaped) housing for its drive, wherein e. g. the housing can preferably annularly encase the drive. It is possible that the first joint structure, for cooling its drive, has, expediently externally, at least one cooling body (e.g. at least one cooling fin or cooling channel, etc.) and/or is equipped with an active cooling (e.g. for cooling by means of air, in particular compressed air, or for cooling by means of a cooling liquid).

It is possible that the second joint structure comprises a drive (e.g. motor, in particular electric motor) in order to rotate the second joint structure about the second axis. The drive of the second joint structure can be coupled, e. g. without own housing and/or without own bearing, to the second joint structure. The drive of the second joint structure can, e. g., be configured as a kit motor, which preferably comprises a rotor and a stator. In particular, the second joint structure can form a (e.g. ring-shaped) housing for its drive, wherein e. g. the housing can preferably annularly encase the drive. It is possible that the second joint structure, for cooling its drive, has, expediently externally, at least one cooling body (e.g. at least one cooling fin or cooling channel, etc.) and/or is equipped with an active cooling (e.g. for cooling by means of air, in particular compressed air, or for cooling by means of a cooling liquid).

It is possible that the third joint structure comprises a drive (e.g. motor, in particular electric motor) in order to rotate the third joint structure about the third axis. The drive of the third joint structure can be coupled, e. g. without own housing and/or without own bearing, to the third joint structure. The drive of the third joint structure can, e. g., be configured as a kit motor, which preferably comprises a rotor and a stator. In particular, the third joint structure can form a (e.g. ring-shaped) housing for its drive, wherein e. g. the housing can preferably annularly encase the drive. It is possible that the third joint structure, for cooling its drive, has, expediently externally, at least one cooling body (e.g. at least one cooling fin or cooling channel, etc.) and/or is equipped with an active cooling (e.g. for cooling by means of air, in particular compressed air, or for cooling by means of a cooling liquid).

The drive of the third joint structure can comprise e. g. a direct drive and/or e. g. be configured gearless. The direct drive can, e. g., comprise a direct motor, in particular torque motor. In the context of the disclosure, direct drive includes, e. g., drives in which the drive part and the working and/or output part are expediently directly connected without gear.

Highest precision without play and hysteresis loss can be realized advantageously by means of the direct drive.

It is possible that the additional line feed-through and preferably the at least one further line extends through the drive and/or the gear of the first joint structure. Alternatively or additionally, the additional line feed-through and preferably the at least one further line can extend through the drive and/or the gear of the third joint structure.

It is possible that the drive of the first joint structure comprises a motor hollow shaft and/or a gear hollow shaft, through which the additional line feed-through and, e. g., the at least one further line extends.

It is possible that the drive of the third joint structure comprises a motor hollow shaft, through which the additional line feed-through and, e. g., the at least one further line extends.

However, the additional line feed-through and, e. g., the at least one further line preferably extends externally past the drive and/or the gear of the second joint structure.

In order to know the positions, in particular the rotary positions, of conventional joint structures, encoders or motor feedback systems on motor shafts are usually used in the prior art in order to be able therewith to indirectly determine the positions of the joint structures. The disadvantage here, however, is that the positions of the output determined in this way can be relatively inaccurate due to, e. g. play, wear, hysteresis, etc. in the drive train.

Measurement and/or detection, in particular directly on the joint structure, e.g. the first joint structure, the second joint structure and/or the third joint structure, and thus preferably on the output, enables an advantageously very high rotary position determination accuracy.

In order to know the positions, in particular the rotary positions, of a joint structure (e.g. the first, the second and/or the third joint structure) as precisely as possible, in the context of the disclosure (e.g. instead of encoders or motor feedback systems on motor shafts), a measuring device (e.g. optical measuring device) can be used by means of which the rotary positions of the joint structure can expediently be measured directly on the joint structure itself, so that, e. g., wear, play and/or hysteresis in the drive train do not lead to any or no significant deterioration in the position determination. This makes it possible, e. g., to ensure an extremely rigid drive train of the joint device by means of post-regulation.

Preferably, a, in particular high-resolution, measuring device, that e. g. measures output-sided, can be used respectively for rotary position measurement of the first joint structure, the second joint structure and/or the third joint structure.

The joint device can, e. g., have a (particularly optical, expediently high-resolution) measuring device for (preferably direct) rotary position measurement of the first joint structure. The measuring device can, e. g., be configured, for rotary position measurement, to detect the first joint structure directly and/or to detect the first joint structure output-sided from the drive of the first joint structure, so that advantageously wear, play and/or hysteresis are not taken into account at the position determination.

It is possible that the measuring device for rotary position measurement of the first joint structure is connected to the first joint structure via a (e. g. substantially play-free and/or preloaded) coupling structure. The coupling structure can, e. g., be rotatable and/or comprise intermeshing teeth. Alternatively or additionally, the coupling structure can, e. g., be configured axis-parallel or angular and/or comprise intermeshing conical gear wheels. The coupling structure can, e. g., comprise a gear wheel pairing or bevel wheel stage.

The joint device can, e. g., have a (particularly optical, expediently high-resolution) measuring device for (preferably direct) rotary position measurement of the second joint structure. The measuring device can, e. g., be configured, for rotary position measurement, to detect the second joint structure directly and/or to detect the second joint structure output-sided from the drive of the second joint structure, so that advantageously wear, play and/or hysteresis are not taken into account at the position determination.

The joint device can, e. g., have a (particularly optical, expediently high-resolution) measuring device for (preferably direct) rotary position measurement of the third joint structure. The measuring device can, e. g., be configured, for rotary position measurement, to detect the third joint structure directly and/or to detect the third joint structure output-sided from the drive of the third joint structure, so that advantageously wear, play and/or hysteresis are not taken into account at the position determination.

It is possible that the measuring device for rotary position measurement of the third joint structure is mounted on the second joint structure and/or is connected to the third joint structure via a (e.g. substantially play-free and/or preloaded) coupling structure. The coupling structure can, e. g., be rotatable and/or comprise intermeshing teeth. Alternatively or additionally, the coupling structure can, e. g., be configured axis-parallel or angular and/or comprise intermeshing conical gear wheels. The coupling structure can, e. g., comprise a gear wheel pairing or bevel wheel stage.

The measuring device of the first joint structure, the measuring device of the second joint structure and/or the measuring device of the third joint structure can, e. g., have a resolution with an error tolerance of 10 arcsec, preferably 5 arcsec, and thus in particular represent a high-resolution measuring device.

The joint device can, e. g., comprise a neutral position in which the first axis and the third axis are substantially coaxially aligned.

It is possible that the offset is between at least 10 mm and a maximum of 100 mm long, e.g. in order not to kink the at least one line at a rotation of the second joint structure about the second axis, but to enable an appropriate bending radius.

The at least one line of the line feed-through can, e. g., comprise at least one of the following:
at least one cable (preferably configured as single wire) for in particular electrical power supply and/or for control of the drive of the second joint structure,
at least one cable (preferably configured as single wire) for in particular electrical power supply and/or for control of the drive of the third joint structure,
at least one cable (preferably configured as single wire) for in particular electrical power supply of the measuring device of the second joint structure,
at least one cable (preferably configured as single wire) for in particular electrical power supply of the measuring device of the third joint structure,
at least one cable (preferably configured as single wire) for data transmission from the measuring device of the second joint structure, e.g. to a control device,
at least one cable (preferably configured as single wire) for data transmission data from the measuring device of the third joint structure, e.g. to a control device,
at least one cable (preferably configured as single wire) for power supply and/or for control of the application apparatus and/or at least one cable (preferably configured as single wire) for power supply and/or for control of the print head device,
at least one line (preferably a cable, e.g. configured as single wire) for e. g. electrical power supply of a braking device for braking the second joint structure,
at least one line (preferably a cable, e.g. configured as single wire) for e. g. electrical power supply of a braking device for braking the third joint structure, and/or
at least one media line for conducting a fluid (e.g. the application agent, air, e.g. compressed air, and/or a rinsing agent).

By using one or more single wires in the line feed-through, the bending radius, in particular the dynamic bending radius, can be significantly minimized compared to a multi-wire cable, as a result of which an even more compact design can be made possible.

However, the additional line feed-through and its at least one further line can preferably be used as follows:

The at least one further line of the additional line feed-through can comprise, e. g., at least one media line for application agent supply, in particular paint supply, of the application apparatus and/or the print head device. Alternatively or additionally, the at least one further line of the additional line feed-through can, e. g., comprise at least one media return line for returning a fluid (e.g. application agent and/or rinsing agent) from the application apparatus and/or the print head device. Alternatively or additionally, the at least one further line of the additional line feed-through can comprise at least one cable for in particular electrical power supply and/or for control of the application apparatus and/or the print head device.

The forced guidance device, the rotary part and/or the cover can preferably be configured hollow circle cylindrical in shape.

The rotary part is preferably a slotted rotary part, e.g. a slotted ring or cylinder.

The joint device can, e. g., comprise an expediently conical (advantageously repeated-accurate) socket-pin arrangement for mastering and/or calibrating the joint device.

The disclosure also includes an application robot, preferably a painting robot, having a joint device as disclosed herein.

The application robot is preferably a multi-axis articulated arm robot, having, e. g., at least 4, at least 5 or at least 6 axes of motion.

It is possible that the third axis has a rotational speed of over 1000, 2000, 3000, 4000 or 5000°/s and/or a torsional rigidity of over 1000, 2000, 3000, 4000 or 5000 or even over 10000 Nm/arcmin.

It should be mentioned that the application apparatus, the print head device and/or the application robot is used in particular for dispensing an application agent (e.g. paint) onto a motor vehicle body component.

The application agent is preferably paint.

The additional line feed-through can, e. g., comprise a hose (e.g. protective and/or guide hose) or a (e.g. partially flexible or substantially rigid) tube (e.g. protective and/or guide tube), in which optionally the at least one further line can run (advantageously protected and/or guided). The hose or the tube can advantageously form a protective cover and/or a guide structure for the at least one further line. The additional line feed-through can preferably form an (e.g. flexible and/or form shaping) empty tube.

It should be mentioned that the first joint structure, the second joint structure and the third joint structure are preferably rotatable relative to each other.

It is possible that a winding up and unwinding area for the line feed-through in the first section is axially limited by a first side wall and the rotary part (e.g. an end face of the rotary part) and, alternatively or additionally, a winding up and unwinding area for the line feed-through in the second section is axially limited by a second side wall and the rotary part (e.g. an end face of the rotary part).

The second side wall can, e. g., be rotatable, in particular rotatable with the first joint structure.

The first side wall is preferably non-rotatable and thus in particular not rotatable with the forced guidance device and/or the rotary part.

The first side wall can, e. g., have a preferably beveled contact surface for the line feed-through. Alternatively or additionally, the second side wall can, e. g., have a preferably beveled contact surface for the line feed-through.

The rotary part can, e. g., taper or narrow in its circumferential direction and/or be narrower on a concave side of the groove than on a convex side of the groove.

A preferably cylindrical base part can be provided, e. g., radially internally, on which the line feed-through can be expediently wound up and unwound. The base part is preferably static and therefore in particular not rotatable with the forced guidance device. The base part is preferably arranged coaxially to the central axis of the forced guidance device.

The rotary part is preferably arranged between the first section and the second section and/or between the side walls.

The line feed-through is preferably a hose or a flexible tube. The line feed-through is preferably configured e.g. not chain-like and/or preferably does not comprise rigid chain links linked to one another in an articulated manner.

The third joint structure can, e. g., be accommodated at least partially in the second joint structure.

It is possible that the first joint structure can have a range of rotation about the first axis of more than +/−340°, e.g. of substantially +/−360° or of at least 360°. Alternatively or additionally, the third joint structure can have a range of rotation about the third axis of more than +/−360° or more than +/−700° or substantially +/−720°.

In the context of the disclosure, advantageously the drive trains can be configured, e. g., as direct as possible and preferably be not coupled to one another. They use, e.g., in the toothing preferably play-free strain wave gears for the first joint structure and/or the second joint structure in order to expediently generate the output torques required here. Due to its often lower load, the third joint structure can, e. g., completely dispense with a gear. Here, a direct drive and/or torque drive can therefore be realized, which advantageously has maximum rigidity without mechanical play.

The preferred embodiments of the disclosure described with reference to the figures correspond in part, wherein similar or identical parts are provided with the same reference signs and reference can also be made to the description of the other embodiments in order to avoid repetitions. For illustration purposes, not all parts in all figures are marked with reference signs.

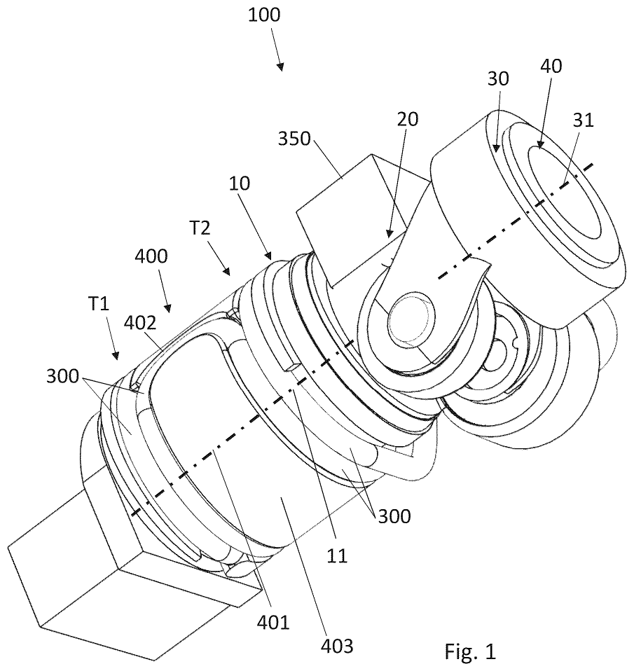

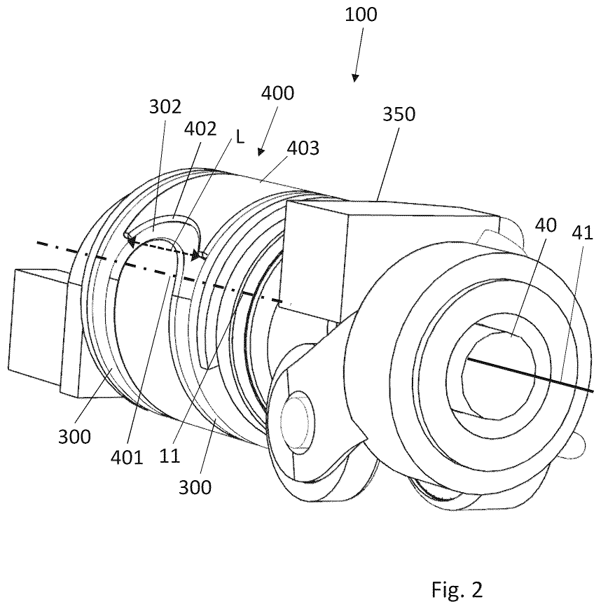

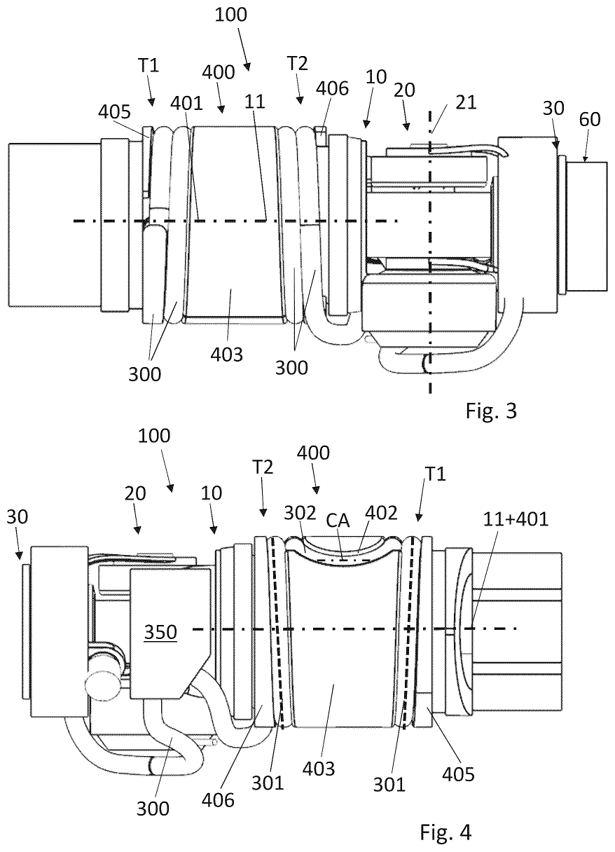

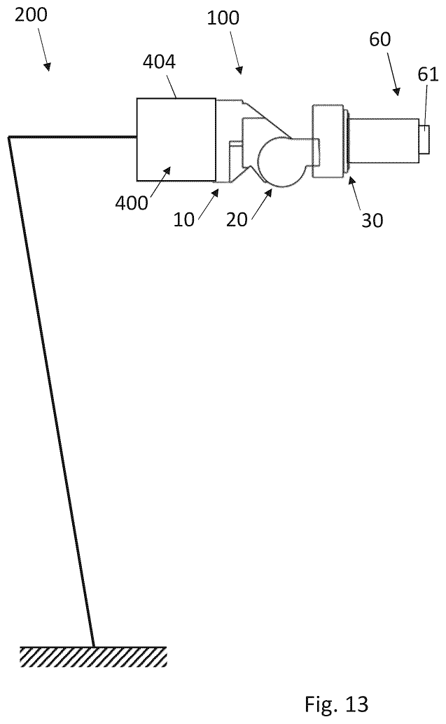

FIGS. 1 to 4 show different views of a joint device 100 according to an embodiment of the disclosure. The joint device 100 is configured as a robot hand (e.g. robot hand axis) and is used in particular for carrying an application apparatus 60 (preferably comprising a print head device 61) and for mounting on an application robot 200 (FIG. 13).

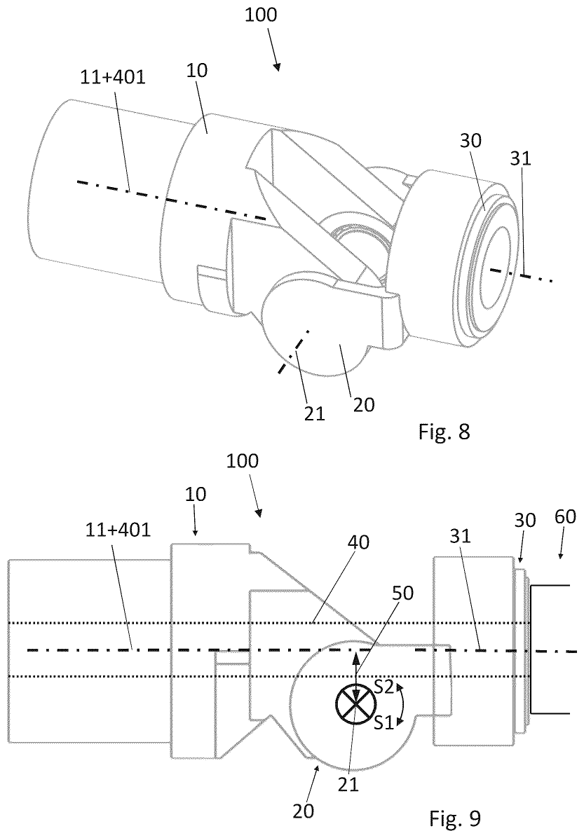

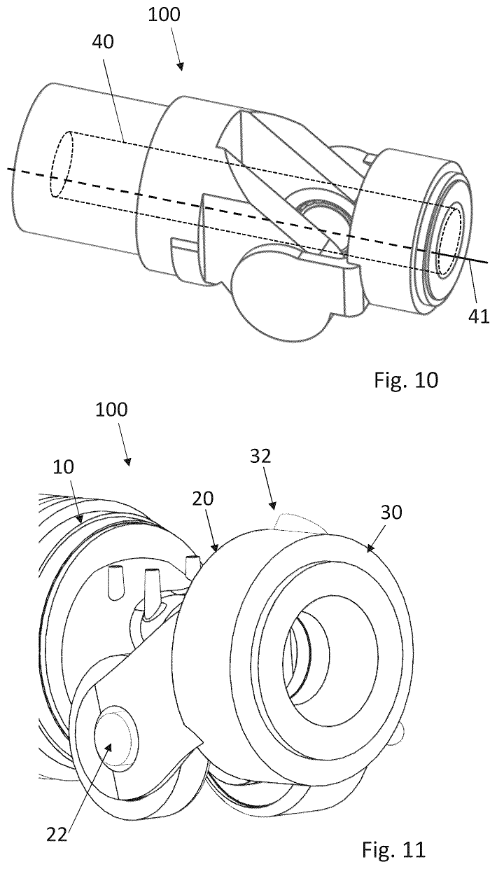

The joint device 100 comprises a kinematics, in particular a first joint structure 10, which is rotatable about a first axis 11, and e. g. a second joint structure 20, which is rotatable about a second axis 21, and preferably a third joint structure 30, which is rotatable about a third axis 31, which are described in more detail below, in particular with reference to FIGS. 8 to 12.

The joint device 100 comprises a line feed-through 300 in which one or more line 301 can run. The line feed-through 300 preferably forms a (e.g. flexible and/or form shaping) empty tube.

The joint device 100 comprises a forced guidance device 400, having a rotary part 403, for forced guidance of the line feed-through 300, wherein the rotary part 403 is rotatable about a central axis 401 of the forced guidance device 400. The first axis 11 and the central axis 401 are preferably substantially coaxially aligned and can thus form one and the same axis. The central axis 401 of the forced guidance device 400 preferably corresponds to the central axis of the rotary part 403.

The forced guidance device 400 is configured expediently cylindrical, in particular hollow cylindrical, and preferably comprises a hollow cylindrical cover 404 shown schematically in FIG. 13. Both the rotary part 403 and the cover 404 are configured preferably substantially hollow circle cylindrical in shape.

The cover 404 can, e. g., be rotatable together with the first joint structure 10 or be non-rotatable. It is also possible that the cover 404 is formed in two or multiple parts, with a first non-rotatable part and a second rotatable part.

The line feed-through 300 is expediently indirectly or directly connected to the first joint structure 10, so that, by rotating the first joint structure 10, in particular the rotary part 403 can be driven by means of the line feed-through 300 and can be rotated relative to the first joint structure 10, in particular with substantially half speed and/or half rotation (e.g. half rotation angle) relative to the first joint structure 10.

If the first joint structure 10 rotates by e. g. 180°, the rotary part 403 preferably rotates by 90°. If the first joint structure 10 rotates by e. g. 90°, the rotary part 403 preferably rotates by 45°. If the first joint structure 10 rotates by e. g. 45°, the rotary part 403 preferably rotates by 22.5°.

The joint device 100 comprises a first section T1 and a second section T2, wherein the first section T1 and the second section T2 are spaced apart from each other in axial direction of the forced guidance device 400.

The line feed-through 300 is configured, by means of rotation of the first joint structure 10, to wind up spirally in the first section T1 and unwind spirally in the second section T2 and vice versa. In other words, the line feed-through 300 winds up in the first section T1 and unwinds correspondingly in the second section T2 by means of rotation of the first joint structure 10, wherein when the first joint structure 10 is rotated in the opposite direction, the line feed-through 300 unwinds in the first section T1 and winds up correspondingly in the second section T2.

The line feed-through 300 can, e. g., be configured to be, by rotating the first joint structure 10, spirally wound up and unwound at least half a time, at least once, at least once and a half times, at least twice, at least twice and a half times, at least three times or at least three and a half times. Depending on how many windings are stored, the range of movement of the kinematics and in particular of the first joint structure 10 can be increased.

The line feed-through 300 extends in the first section T1 and in the second section T2 in opposite directions spirally around the central axis 401 of the forced guidance device 400.

The rotary part 403 comprises a groove 402, in which the line feed-through 300 is accommodated in an expediently force-guided manner.

The groove 402 is formed in the rotary part 403 in particular arc-shaped, in order to form a deflecting arc for deflecting the line feed-through 300. Consequently, the line feed-through 300 with its section 302 also runs arc-shaped in the groove 402. The rotary part 403 thus represents a rotary part 403 slotted in particular by means of the groove 402.

The section 302 in particular enables a force transmission from the line feed-through 300 to the rotary part 403 in circumferential direction of the rotary part 403, so that the rotary part 403 can be set into a rotation about the central axis 401 of the forced guidance device 400.

The groove 402 is arranged between the first section T1 and the second section T2 in order to connect the line feed-through 300 in the first section T1 to the line feed-through 300 in the second section T2.

The groove 402 is rotatable expediently together with the rotary part 403 about the central axis 401 and is delimited by a convex partial segment and an opposite concave partial segment of the rotary part 403.

The groove 402 and the section 302 can, e. g, have a passage cross-section with a center axis CA aligned substantially parallel to the central axis 401. The groove 402 and the arc-shaped section 302 can also have a chord L, which can run substantially parallel to the central axis 401.

The line feed-through 300 comprises at least one winding in the first section T1 and branches off from the winding laterally into the groove 402. The line feed-through 300 also comprises at least one winding in the second section T2 and branches off from the winding laterally into the groove 402.

A winding up and unwinding area for the line feed-through 300 in the first section T1 can be axially delimited by a first side wall 405 and the rotary part 403, wherein a winding up and unwinding area for the line feed-through 300 in the second section T2 can be axially delimited by a second side wall 406 and the rotary part 403.

The second side wall 406 can, e. g., be rotatable in particular with the first joint structure 10. The first side wall 405 is preferably non-rotatable.

The first side wall 405 can, e. g., have a beveled contact surface for the line feed-through 300. The second side wall 406 can also have, e. g., a beveled contact surface for the line feed-through 300.

A preferably cylindrical base part 407 is provided radially internally, on which the line feed-through 300 can be expediently wound up and unwound. The base part 407 is preferably static and thus in particular not rotatable with the forced guidance device 400.

The rotary part 403 can expediently taper or narrow, e. g. so that it is narrower on a concave side of the groove 402 than on a convex side of the groove 402.

The rotary part 403 and thus also the groove 402 is expediently axially slidable. The rotary part 403 is slid back and forth in particular along the central axis 401, when the line feed-through 300 is wound up and unwound.

The rotary part 403 can, e. g., slide to a first side when the line feed-through 300 is unrolled on the first side and rolled up on the second side, and vice versa. The line feed-through 300 is slid e. g. partially through the groove 402, e. g. partially slid into the groove 402 and partially slid out of the groove 402, when the first joint device 10 and thus the rotary part 403 is rotated together with the groove 402 in order to enable the line feed-through 300 to be wound up in the first section T1 and unwound in the second section T2 and vice versa.

In the first section T1, the line feed-through 300 is non-slidably attached (e.g. fixed) expediently at a first attaching point. In the second section T2, the line feed-through 300 is non-slidably attached (e.g. fixed) expediently at a second attaching point, wherein the second attaching point is rotatable relative to the first attaching point. The first joint structure 10 is expediently connected to the second attaching point directly or indirectly in order to rotate the second attaching point and thus the line feed-through 300.

As already mentioned, the line feed-through 300 is connected to the first joint structure 10, wherein, by rotating the first joint structure 10, in particular the rotary part 403 can be driven and rotated by means of the line feed-through 300, in particular with substantially reduced (e.g. half) speed and/or reduced (e.g. half) rotation relative to the first joint structure 10.

The rotary part 402 thus preferably rotates, with half speed and/or with half rotation or generally with reduced speed and/or reduced rotation angle (e.g. reduced rotation), with the first joint structure 10.

Understanding the principle of operation can be facilitated by using the pulley block principle as an analogy, in particular a pulley block with a fixed pulley and a movable pulley. A length of rope, with which a rope is pulled, is divided by the movable pulley, so that the movable pulley is only moved half as far as the length of rope, with which the rope is pulled.

As already mentioned, the forced guidance device 400 comprises an expediently hollow cylindrical cover 404. The cover 404 is preferably used for externally covering the rotary part 403, the section 302, the line feed-through 300 in the first section T1 and/or the line feed-through 300 in the second section T2. The cover 404 is arranged coaxially to the rotary part 403.

The cover 404 can have an outer sheath, wherein a passage opening is formed in the outer sheath, from which the line feed-through 300 extends.

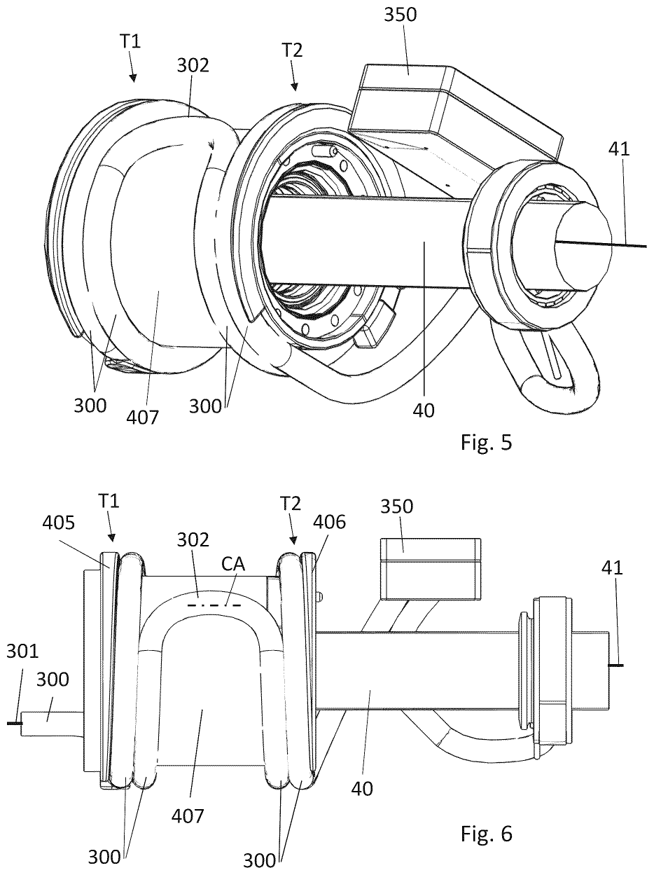

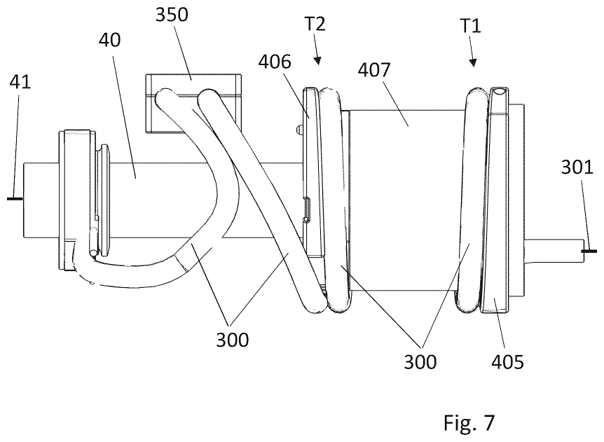

FIGS. 5 to 7 show different views, in particular of the line feed-through 300 and an optional additional line feed-through 40.

At least one schematically indicated line 301 runs in the line feed-through 300.

At least one schematically indicated further line 41 runs in the additional line feed-through 40.

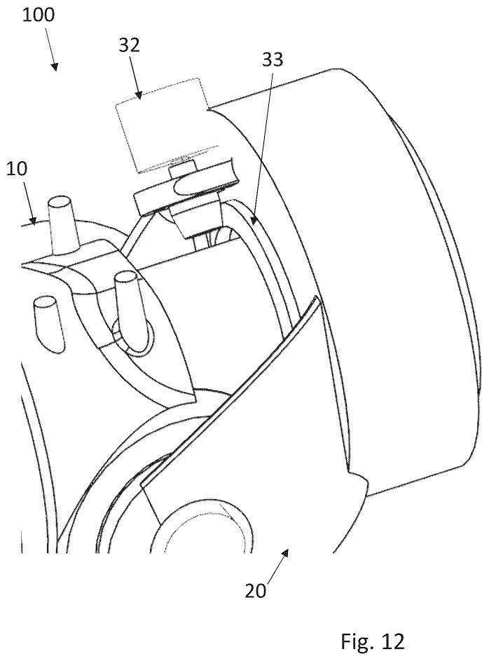

The at least one line 301 of the line feed-through 300 can in particular comprise at least one of the following:
at least one cable for in particular electrical power supply and/or for control of a drive of the second joint structure 20 and/or a drive of the third joint structure 30,
at least one cable for in particular electrical power supply of a measuring device 22 (FIG. 11) for rotary position measurement of the second joint structure 20 and/or a measuring device 32 (FIG. 12) for rotary position measurement of the third joint structure 30,
at least one cable for data transmission from the measuring device 22 of the second joint structure 20 and/or the measuring device 32 of the third joint structure 30,
at least one cable for in particular electrical power supply and/or for control of the application apparatus 60 and/or the print head device 61, and/or
at least one media line for conducting a fluid (e.g. application agent, rinsing agent and/or air, in particular compressed air).

The at least one line 301 and/or the line feed-through 300 are preferably connected to a distributor box 350, wherein the distributor box 350 can be attached to the first joint structure 10, in particular in order to rotate with the first joint structure 10.

The at least one further line 41 of the additional line feed-through 40 can in particular comprise at least one of the following:
at least one media line for application agent supply and/or for fluid supply (e.g. air, in particular compressed air, and/or rinsing agent, etc.) of the application apparatus 60 and/or the print head device 61,
at least one media return line for returning a fluid from the application apparatus 60 and/or the print head device 61, and/or
at least one cable for in particular electrical power supply and/or for control of the application apparatus 60 and/or the print head device 61.

In a particularly preferred embodiment, it is possible that in particular cables for control, for electrical power supply and optionally for data transmission run in the line feed-through 300, whereas in particular one or more media lines for fluids (e.g. application agent, rinsing agent and/or compressed air) run in the line feed-through 40. This makes it advantageously possible to separate cables and media lines.

FIGS. 8 to 12 show different views of the previously described joint device 100, wherein the line feed-through 300 and the forced guidance device 400 are not shown.

The joint device 100 comprises a first joint structure 10, which is rotatable about a first axis 11, a second joint structure 20, which is rotatable about a second axis 21, and a third joint structure 30, which is rotatable about a third axis 31. Thus, the first joint structure 10, the second joint structure 20 and the third joint structure 30 are rotatable relative to each other.

The first joint structure 10 can preferably be a kinematically inlet-sided joint structure of the joint device 100, wherein the third joint structure 30 can in particular be a kinematically outlet-sided joint structure of the joint device 100.

The second joint structure 20 can preferably be coupled kinematically between the first joint structure 10 and the third joint structure 30 and, e. g., form a connecting structure of the first joint structure 10 with the third joint structure 30.

The joint device 100 can comprise an application apparatus 60, which can only be partially seen in FIG. 9 and which can be carried expediently directly or indirectly by means of the joint device 100, in particular by means of the third joint structure 30. The application apparatus 60 can in particular comprise a print head device 61 (FIG. 13), wherein the print head device 61 can have a plurality of nozzles for dispensing an application agent (e.g. paint) onto a motor vehicle body component (e.g. a body and/or an attachment part therefor). The application agent can, e. g., be dispensed from the nozzles in the form of contiguous application agent jets and/or, e. g., in the form of application agent droplets, etc. The print head device 61 is used in particular for substantially overspray-free coating, in particular painting.

The joint device 100 can comprise an optional additional line feed-through 40 which extends through forced guidance device 400, through the first joint structure 10 and e. g. through the third joint structure 30 and in which preferably at least one further optional line 41 e. g. for the application apparatus 60 and/or for the print head device 61 runs.

The additional line feed-through 40 can, e. g., comprise a hose or a (e. g. partially flexible) tube, in which the at least one further line 41 can run preferably in a protected and guided manner. The hose or the tube can thus form a protective cover and/or a guiding structure for the at least one further line 41.

The joint device 100 also comprises a fixed offset 50 between the first axis 11 and the second axis 21. The offset 50 can, e. g., be between at least 10 mm and a maximum of 100 mm long.

The at least one further line 41, which runs in the additional line feed-through 40, preferably serves for application agent supply and thus in particular for paint supply of the print head device 61. However, the at least one further line 41 can also serve, e. g., for electrical power supply, for control and/or for fluid supply (e.g. air, compressed air and/or rinsing/cleaning agent) of the application apparatus 60 and/or the print head device 61. The at least one further line 41 can also comprise, e. g., a data cable by means of which data can be transmitted from and/or to the print head device 61 and/or the application apparatus 60.

The additional line feed-through 40 can preferably also extend through the second joint structure 20.

The first axis 21 and the third axis 31 can extend in a common plane.

The second axis 21 crosses the common plane, preferably substantially orthogonally.

FIG. 9 shows the joint device 100 in a neutral position, in which the first axis 11 and the third axis 31 are substantially coaxially aligned.

In order to rotate the first joint structure 10 about the first axis 11, the first joint structure 10 comprises a drive. The drive comprises in particular a drive motor (e.g. electric motor) and is coupled, preferably without own housing and/or without own bearing, to the first joint structure 10. The drive of the first joint structure 10 can thus be configured as, e. g., a kit motor. The drive of the first joint structure 10 can comprise a motor hollow shaft and, e.g., a gear hollow shaft, through which the additional line feed-through 40 and the at least one further line 41 can extend.

In order to rotate the second joint structure 20 about the second axis 21, the second joint structure 20 comprises a drive. In The drive comprises in particular a drive motor (e.g. electric motor) and is coupled, preferably without own housing and/or without own bearing, to the second joint structure 20. The drive of the second joint structure 20 can thus be configured as, e. g., a kit motor. The additional line feed-through 40 and the at least one further line 41 extend expediently externally past the drive and/or the gear of the second joint structure 20.

In order to rotate the third joint structure 30 about the third axis 31, the third joint structure 30 comprises a drive. The drive comprises in particular a drive motor (e.g. electric motor) and is coupled, preferably without own housing and/or without own bearing, to the third joint structure 30. The drive of the third joint structure 30 can thus be configured as, e. g., a kit motor. The drive of the third joint structure 30 can comprise a motor hollow shaft, through which the additional line feed-through 40 and the at least one further line 41 can extend.

It is therefore particularly preferred that preferably all three joint structures 10, 20 and 30 can be driven via motors which can be integrated without own housings directly into the respective joint structure 10, 20 and 30. Thereby, the joint structures 10, 20 and 30 can respectively form an expediently ring-shaped housing for their drive.

The drive of the third joint structure 30 can, e. g., comprise a direct motor or a torque motor, and/or be configured e. g. gearless. Direct motor, torque motor and/or gearless drive includes in particular drives in which the drive part and the working and/or output part are connected without gear expediently directly to each other.

The first joint structure 10 can comprise a gear, preferably a substantially play-free strain wave gear. The second joint structure 20 can also comprise a gear, preferably a substantially play-free strain wave gear.

A strain wave gear (e. g. also known as tension strain wave gear, sliding wedge gear or according to the English designation strain wave gear (SWG) is a gear with, in particular, an elastic transmission element, which is advantageously characterized by an expediently high gear ratio and expediently high rigidity.

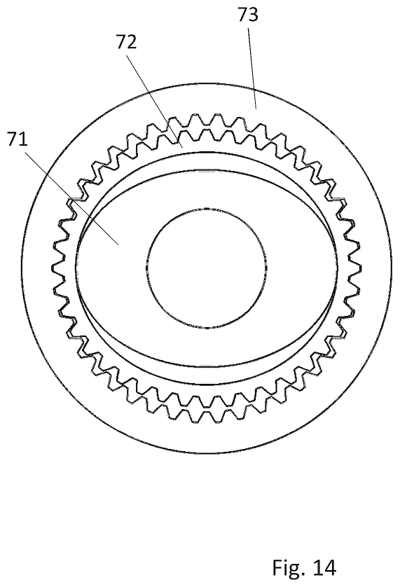

A strain wave gear, as can preferably be used for the first joint structure 10 and/or the second joint structure 20, is described below with reference to FIG. 14.

The strain wave gear comprises in particular an elliptical disk 71, a deformable substantially cylindrical bushing 72 with external toothing and a substantially cylindrical outer ring 73 with internal toothing.

The elliptical disk 71 (e.g. wave generator) can, e. g., include a centric hub and a (expediently thin and/or elliptically) deformable bearing (e.g. ball or roller bearing). The elliptical disk 71 preferably serves as drive element of the gear. The cylindrical bushing 72 (e.g. flexspline) serves in particular as output element of the gear. The outer ring 73 (e.g. circular spline) can preferably surround the elliptical disk 71 and the bushing 72 and/or form a housing for the elliptical disk 71 and the bushing 72.

FIG. 11 shows a perspective view of the joint device 100, wherein in particular a measuring device 22 can be seen in FIG. 11.

The measuring device 22 is used for (preferably direct) rotary position measurement of the second joint structure 20, wherein the measuring device 22 can, e. g., be configured, for rotary position measurement, to detect the second joint structure 20 directly and/or to detect (e.g. optically, with spatial spacing, with physical engagement, contacting or contactless, etc.) it output-sided from the drive of the second joint structure 20. This makes it advantageously possible that wear, play and/or hysteresis in the drive train do not lead to any or no significant deterioration in the accuracy of the position determination.

FIG. 12 shows a perspective view of the joint device 100, wherein in particular a measuring device 32 can be seen in FIG. 12.

The measuring device 32 is used for (preferably direct) rotary position measurement of the third joint structure 30, wherein the measuring device 32 can, e. g., be configured, for rotary position measurement, to detect the third joint structure 30 directly and/or to detect (e.g. optically, with spatial spacing, with physical engagement, contacting or contactless, etc.) it output-sided from the drive of the third joint structure 30. This makes it advantageously possible that wear, play and/or hysteresis in the drive train do not lead to any or no significant deterioration in the accuracy of the position determination.

It is possible, e. g., as can be seen in FIG. 12, that the measuring device 32 for rotary position measurement of the third joint structure 30 is mounted, e. g., on the second joint structure 20 and, in particular, is connected to the third joint structure 30 via a preferably substantially play-free, preloaded coupling structure 33, preferably a gear wheel pairing and/or a bevel wheel stage, in order to thus enable a direct and/or output-sided rotary position measurement. The coupling structure 33 is preferably configured angularly, e.g. as a bevel wheel stage, wherein axis-parallel coupling structures 33 are also possible. In particular, the coupling structure 33 can comprise intermeshing (e.g. conical) gear wheels.

A rotary position measurement of the first joint structure 10 can be realized in a similar way as with the second joint structure 20 or the third joint structure 30.

Thus, a measuring device can be provided for (preferably direct) rotary position measurement of the first joint structure 10, wherein the measuring device can, e. g., be configured, for rotary position measurement, to detect the first joint structure 10 directly and/or to detect (e.g. optically, with spatial spacing, with physical engagement, contacting or contactless, etc.) it output-sided from the drive of the first joint structure 10. This makes it advantageously possible that wear, play and/or hysteresis in the drive train do not lead to any or no significant deterioration in the accuracy of the position determination.

It is possible that the measuring device for rotary position measurement of the first joint structure 10 is connected to the first joint structure 10 via a preferably substantially play-free, preloaded coupling structure, preferably a gear wheel pairing and/or a bevel wheel stage, in order to thus enable a direct and/or output-sided rotary position measurement. The coupling structure is preferably configured axis-parallel, e.g. by means of intermeshing (e. g. conical) gear wheels, wherein angular coupling structures are also possible.

The measuring devices, as previously discussed, can, e. g., be optical, expediently high-resolution measuring devices, in particular with a resolution with an error tolerance of 10 or 5 arcsec (arcsec=angular seconds). However, the measuring devices are not limited to optical measuring devices, but can include any other suitable measuring technology.

FIG. 13 shows a schematic view of an application robot 200 with joint device 100.

The application robot 200 is preferably a painting robot and carries an application apparatus 60 by means of the joint device 100. The application apparatus 60 preferably comprises a print head device 61 with a plurality of nozzles for dispensing the application agent (e.g. paint). However, the application apparatus 60 can also comprise an applicator other than a print head, e.g. an atomizer or only one nozzle, etc.

Substantial advantages are, e. g.:
Decentralized, yet compact line guidance by means of the line feed-through 300, in particular externally around the first axis 11,
Combination option with central line feed-through 40, e.g. to increase the capacity and/or separation of media lines (e.g. for application agent, air and/or rinsing agent) and electrical cables,
Realization of large swivel ranges with short axial installation space,
Routing of single wires instead of a multi-wire cable for an even more compact design,
Mechanical protection as well as protection against dirt and easy cleaning by means of the cover 404, and/or
Good accessibility for repair and maintenance works (hose and cable replacement).

The disclosure is not limited to the preferred embodiments described above. Rather, a large number of variants and modifications are possible which also make use of the concept of the disclosure and therefore fall within the scope of protection. In addition, the disclosure also claims protection for the subject matter and the features of the subclaims independently of the features and claims referred to.

1.-39. (canceled)

40. A robot hand for carrying a print head device, comprising
a first joint structure which is rotatable about a first axis, and
a line feed-through preferably in which at least one line runs, wherein
the joint device comprises a forced guidance device, having a rotary part, for forced guidance of the line feed-through, and the rotary part is rotatable about a central axis of the forced guidance device.

41. The robot hand according to claim 40, wherein the forced guidance device comprises a preferably hollow-cylindrical cover.

42. The robot hand according to claim 41, wherein the cover is rotatable together with the first joint structure.

43. The robot hand according to claim 40 wherein the first axis of the joint structure and the central axis of the forced guidance device are aligned substantially coaxially to each other.

44. The robot hand according to claim 42, wherein the line feed-through is connected to the first joint structure in order, by rotating the first joint structure, in particular to drive and rotate the forced guidance device and/or the rotary part by means of the line feed-through.

45. The robot hand according to claim 42, wherein the line feed-through is connected to the first joint structure in order, by rotating the first joint structure, to rotate the forced guidance device and the rotary part with the line feed-through with one of a reduced speed or a reduced rotation angle relative to the first joint structure.

46. The robot hand according to claim 40, wherein the joint device comprises a first section (T1) and a second section (T2) and the first section (T1) and the second section (T2) are spaced apart from each other in axial direction of the forced guidance device.

47. The robot hand according to claim 46, wherein the line feed-through is configured, by rotating the first joint structure in a first direction of rotation, to be unwound in the first section and wound up in the second section and, by rotating the first joint structure in a second direction of rotation opposite to the first direction of rotation, to be unwound in the second section and wound up in the first section.

48. The robot hand according to claim 46, wherein the line feed-through is configured
to be spirally, wound up and unwound at least half a time, at least once, at least once and a half times or at least twice in the first section, and
to be spirally, wound up and unwound at least half a time, at least once, at least once and a half times or at least twice in the second section.

49. The robot hand according to claim 42, wherein the rotary part has a groove in which the line feed-through is accommodated, preferably forcibly guided.

50. The robot hand according to claim 49, wherein the groove is arc-shaped and forms a deflecting arc for deflecting the line feed-through.

51. The robot hand according to claim 49, wherein the groove
is rotatable about the central axis of the forced guidance device, and
is delimited by a convex partial segment and an opposite concave partial segment, and
is arranged between the first section and the second section to connect the line feed-through in the first section to the line feed-through in the second section.

52. The robot hand according to claim 49, wherein the line feed-through has a section running in the groove in an arc-shaped manner, to enable a force transmission from the line feed-through to the rotary part, so that the rotary part is set into a rotation about the central axis of the forced guidance device.

53. The robot hand according to claim 49, wherein the line feed-through is partially slidable through the groove.

54. The robot hand according to claim 40, wherein the rotary part is configured to be axially slidable.

55. The robot hand according to claim 49, wherein the groove has a passage cross-section with a center axis aligned substantially parallel to the central axis of the forced guidance device.

56. The robot hand according to claim 46, wherein the line feed-through extends in the first section and in the second section in opposite directions spirally around the central axis of the forced guidance device.

57. The robot hand according to claim 46 wherein the line feed-through is attached in the first section to a first attaching point and is attached in the second section to a second attaching point and the second attaching point is rotatable relative to the first attaching point.

58. The robot hand according to claim 57, wherein the first joint structure is connected to the second attaching point to rotate the second attaching point.

59. The robot hand according to claim 40, wherein at least one line is connected to a distributor box and the distributor box is attached to the first joint structure to rotate with the first joint structure.

60. The robot hand according to claim 41, wherein the cover is configured to externally cover the groove, the rotary part, the arc-shaped section of the line feed-through, the line feed-through in the first section and the line feed-through in the second section.

61. The robot hand according to claim 41 wherein the cover has an outer sheath, wherein a passage opening is formed in the outer sheath, out of which passage opening the line feed-through extends.

62. The robot hand according to claim 41, wherein the cover is configured to be removable and is arranged coaxially to the central axis of the forced guidance device.

63. The robot hand according to claim 40, wherein the rotary part either tapers or narrows in its circumferential direction, or is narrower on a concave side of the groove than on a convex side of the groove.

64. The robot hand according to claim 46, wherein a winding up and unwinding area for the line feed-through in the first section is axially limited by a first side wall and the rotary part, and a winding up and unwinding area for the line feed-through in the second section is axially limited by a second side wall and the rotary part.

65. The robot hand according to claim 40 wherein the line feed-through is configured as a flexible tube.

66. The robot hand according to claim 40, wherein the joint device further comprises
a second joint structure which is rotatable about a second axis, and
a third joint structure which is rotatable about a third axis.

67. The robot hand according to claim 40, wherein the joint device has an additional line feed-through preferably in which at least one further line runs and which extends in one of an axial direction through the rotary part of the first joint structure or the third joint structure.

68. The robot hand according to claim 66 wherein an offset is formed between the first axis and the second axis, so that the first axis and the second axis are arranged offset relative to one another.

69. The robot hand according to claim 66, wherein the first axis and the third axis extend in a common plane and the second axis crosses a common plane.

70. The robot hand according to claim 40, wherein at least one of the first, second or third joint structures includes a drive.

71. The robot hand according to claim 71, wherein the drive of the first joint structure is coupled, without a housing to the first joint structure.

72. The robot hand according to claim 70 wherein
the first joint structure forms a housing for its drive, and/or
the second joint structure forms a housing for its drive, and/or
the third joint structure forms a housing for its drive.

73. The robot hand according to claim 40, wherein the joint device has a measuring device for rotary position measurement of at least one of the first. Second or third joint structures.

74. The robot hand according to claim 40, wherein the at least one line of the line feed-through comprises at least one of the following:
at least one power supply cable or control of the drive of the second joint structure or the drive of the third joint structure and
at least one data transmission cable from the measuring device of the second joint structure and/or the measuring device of the third joint structure, and
at least one line for power supply of a braking device for braking the second joint structure or for power supply of a braking device for braking the third joint structure.

75. The robot hand according to claim 74, wherein at least one of the cables is configured as single wire.

76. The robot hand according to claim 67, wherein the at least one further line of the additional line feed-through comprises at least one of the following:
at least one media line for application agent supply and/or for fluid supply of the application apparatus and/or the print head device,
at least one media return line for returning a fluid from the application apparatus and/or the print head device, and/or
at least one cable for power supply and/or for control of the application apparatus and/or the print head device.
